(19) United States
(12) Patent Application Publication
(10) Pub. No.: US 2020/0065739 A1
(43) Pub. Date: Feb. 27, 2020

(54) FRAMEWORK FOR ADJUSTING CONTRIBUTOR PROFILE IN COLLECTING DATA LABELS

(71) Applicant: Figure Eight Technologies, Inc., San Francisco, CA (US)

(72) Inventors: Natã Miccael Barbosa, Syracuse, NY (US); Monchu Chen, Mountain View, CA (US); Jennifer Prendki, Mountain View, CA (US)

(21) Appl. No.: 16/245,121

(22) Filed: Jan. 10, 2019

Related U.S. Application Data
(60) Provisional application No. 62/720,836, filed on Aug. 21, 2018.

(51) Int. Cl. G06Q 10/06; G06F 16/9035; G06F 9/445

(52) U.S. Cl. CPC G06Q 10/063112; G06Q 10/063114; G06F 9/4451; G06F 16/9035

(57) ABSTRACT

A profile configuration comprising desired feature configurations for contributors for a task is provided. Among a plurality of available contributors, a selected set of one or more contributors that substantially meets a set of one or more objectives is identified, with the identification being based at least in part on the profile configuration. The selected set of one or more contributors is recruited to perform the task.

### CROSS REFERENCE TO OTHER APPLICATIONS

This application claims priority to U.S. Provisional Patent Application No. 62/720,836 entitled FRAMEWORK FOR ADJUSTING CONTRIBUTOR PROFILE IN COLLECTING DATA LABELS filed Aug. 21, 2018 which is incorporated herein by reference for all purposes.

### BACKGROUND OF THE INVENTION

Crowdsourcing is useful for performing a number of tasks. In the digital age, crowdsourcing has been used to allow tasks that computers cannot perform on their own to be performed by paid crowds. Types of tasks for which crowdsourcing has been used include annotation, transcription, judgment, and/or other tasks. Computerized platforms have been developed to manage crowdsourcing of tasks. Although useful, traditional crowdsourcing platforms suffer from a number of drawbacks. For example, contributors may be unqualified for some of the tasks they are asked to perform, resulting in low-quality contributions; contributors may introduce their personal biases when making contributions, thus skewing the results; and contributors may not be paid fair wages, causing the number of participants to go down over time. Consequently, research into crowdsourcing is ongoing, and there is a need to improve computerized crowdsourcing platforms to obtain higher quality, unbiased contributions while properly compensating the contributors.

### BRIEF DESCRIPTION OF THE DRAWINGS

Various embodiments of the invention are disclosed in the following detailed description and the accompanying drawings.

FIG. 1 is a block diagram illustrating an embodiment of a system for implementing a framework for recruiting contributors.

FIG. 2 illustrates examples of profile configurations used in some embodiments.

FIG. 3 is a flow chart illustrating an embodiment of a process for recruiting contributors in accordance with a profile configuration.

FIGS. 4A-4B are example visual representations of significant steps in an embodiment of a process for recruiting contributors in accordance with a profile configuration.

FIG. 5 is a flow chart illustrating an embodiment of a process for identifying a set of contributors that substantially meets a set of one or more objectives.

FIG. 6A is a diagram illustrating an example of a multi-objective optimization.

FIG. 6B is a diagram illustrating an example of a three-dimensional optimization.

FIG. 7 is a flow chart illustrating an embodiment of a process for recruiting a subset of contributors from candidate subsets of different sizes.

FIGS. 8A-8C illustrate examples of distributions of specific features related to contributors for a specific task, without and with a framework for recruiting contributors to meet objectives specified in a profile configuration.

FIG. 9 is a flow chart illustrating an embodiment of a process for determining when to commence or continue recruiting of contributors.

FIG. 10 is a diagram illustrating an example of a prediction model's predictions.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A framework for recruiting contributors is disclosed. In various embodiments, contributors are recruited for crowdsourcing tasks (also referred to as tasks). Examples of tasks include audio transcription, image/video classification/categorization, audio/video/photo/other data annotation, content moderation, relevance judgments, and other tasks. Contributors (also referred to as agents) contribute transcriptions, classifications, annotations, judgments, and/or any other type of contribution requested of them. Contributors/agents include people (i.e., human contributors/agents) and computer programs (i.e., software contributors/agents). In some embodiments, contributions are received from both human contributors/agents and software contributors/agents. In various embodiments, human contributors are recruited from across the world. Recruiting a human contributor typically includes inviting, soliciting, and/or ordering the human contributor to work on a task. Recruiting a software contributor typically includes selecting a computer program to work on a task. In various embodiments, for each task, a profile configuration comprising desired feature configurations for contributors for the task is used by a contributor recruitment component. Examples of desired features that are configurable include gender distribution, age distribution, language distribution, country of origin distribution, historical accuracy as measured from prior work, contributors for which a task would be similar/dissimilar from other tasks, contributor crowdsourcing experience, hourly wage, and number of contributors. Desired feature configurations typically vary depending on the task. For example, desired gender distributions might be different for a content moderation task versus an image annotation task. In this sense, in various embodiments, contributor profiles associated with collecting data labels are adjusted. In various embodiments, a selection (e.g., a group) of contributors is identified with a goal of having the selection have the desired features specified in a profile configuration. For example, if a desired feature specified in a profile configuration is a balanced gender distribution (e.g., equal numbers of males and females), then one objective in identifying contributors to potentially recruit for the task is to identify contributors in a manner such that a balanced gender distribution among contributors is achieved. In various embodiments, more than one desired feature is specified in a profile configuration, and thus there are multiple objectives when identifying contributors to recruit. In various embodiments, a multi-objective optimization is performed to identify a selected set of one or more contributors (e.g., a subset of a pool of available contributors) that substantially meets a set of one or more objectives derived from a profile configuration. In some embodiments, a prediction model (e.g., a machine learning model, such as a long short-term memory (LSTM) neural network) is used to determine when to commence (or continue) recruiting of contributors for a task. In some embodiments, an LSTM is trained on historical data of feature configurations of available contributors during various times during a 24-hour period in order to predict one or more times during which feature configurations of available contributors would be substantially similar to desired feature configurations specified in a profile configuration for a task. In various embodiments, recruiting commences (or continues) during times determined by the prediction model (e.g., an LSTM neural network).

As will be further described herein, the contributor recruitment framework described herein has several benefits. In some embodiments, at any given moment, available contributors that are qualified to work on a particular task may number in the thousands or more. Identifying a subset (of contributors from a myriad of available contributors) that substantially meets numerous objectives would not be feasible without an automated framework. In particular, multi-objective optimization used in various embodiments to identify subsets of contributors requires computer assistance and a framework. As will be further described herein, by employing such a framework, benefits such as higher quality contributions, reduced bias in contributions, and better paid workers can be achieved and/or managed. Biases in contributions can be reduced in a collective sense (e.g., biases of contributions in the aggregate).

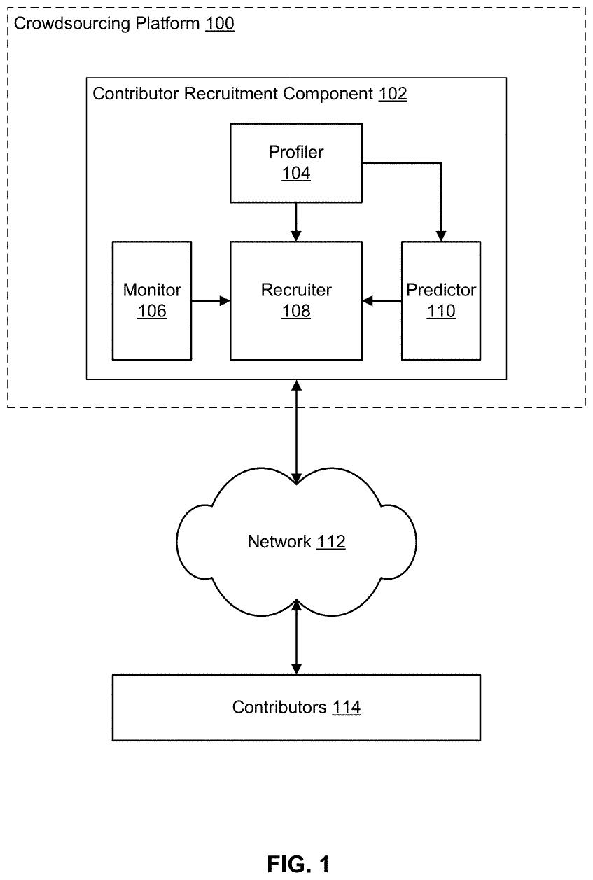

FIG. 1 is a block diagram illustrating an embodiment of a system for implementing a framework for recruiting contributors. In the example shown, the system includes contributor recruitment component 102 (a part of crowdsourcing platform 100), network 112, and contributors 114. Contributor recruitment component 102 includes profiler 104, monitor 106, recruiter 108, and predictor 110. In various embodiments, crowdsourcing platform 100 handles overall coordination associated with crowdsourcing. The illustration of crowdsourcing platform 100 has been simplified to illustrate the example clearly. In addition to recruiting contributors, in various embodiments, crowdsourcing platform 100 also allows contributors to view and perform tasks, collects results from contributors, pays contributors, receives payments from requestors of tasks, manages tasks for which crowdsourcing is requested, stores information related to tasks and contributors, and handles other functions associated with crowdsourcing. Tasks may originate from crowdsourcing platform 100, other platforms connected to crowdsourcing platform 100, and from any other source.

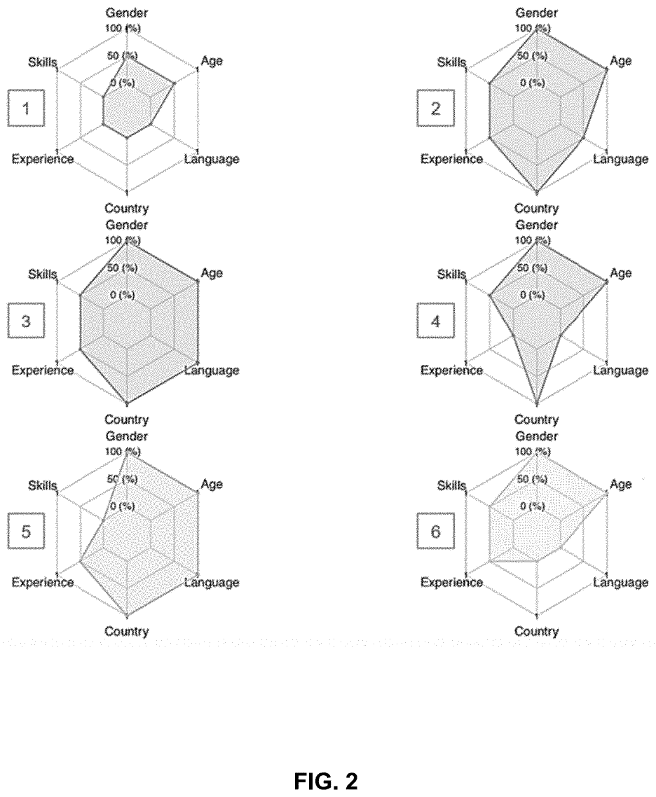

Profiler 104 receives and stores profile configurations. Profile configurations include desired feature configurations for contributors for a task. Examples of desired features of contributors to be configured include gender distribution, age distribution, language distribution, country of origin distribution, historical accuracy as measured from prior work, crowdsourcing experience distribution, similarity of the task to previous tasks, hourly wage, and number of contributors. In some embodiments, profile configurations are a set of metrics that can be visualized graphically (e.g., as a radar chart). For example, as will be described herein, FIG. 2 shows radar chart profile configurations used in some embodiments. In some embodiments, profiler 104 determine traits for which balance is desirable by comparing differences in responses across different populations and determining which traits, when unbalanced, lead to significantly different responses. For example, it is possible to review content moderation tasks and check if differences in answers from men and women are statistically significant (if so, a balanced gender distribution might be desirable). Profiler 104 may proactively suggest profile configurations for specific tasks. Profiler 104 provides stored profile configurations to recruiter 108 and predictor 110.

Monitor 106 monitors contributors and keeps track of contributors that are currently working on or have already worked on a task and available contributors for hire (whether online or offline). For any particular task, monitor 106 stores feature information (e.g., gender, age, language, country of origin, historical accuracy as measured from prior work, and hourly wage) associated with each contributor that is currently working on or has already worked on that particular task. Hourly wage may be associated with a minimum hourly wage in a country where a contributor is located. Monitor 106 provides feature information associated with contributors to recruiter 108.

Recruiter 108 identifies and solicits contributors for a task according to an algorithm that considers a profile configuration comprising desired feature configurations for contributors for the task (e.g., a profile configuration provided by profiler 104), feature information associated with contributors that are currently working or have already worked on the task (e.g., feature information provided by monitor 106), and feature information associated with contributors available for recruiting. Recruiter 108 has access to feature information associated with contributors available for recruiting (e.g., via a network). In various embodiments, an algorithm seeks to identify which contributors, if recruited and combined with the contributors that are currently working or have already worked on the task, would result in the combined contributors achieving a profile configuration substantially similar to a desired profile configuration. In various embodiments, recruiter 108 performs recruiting by soliciting the identified contributors to work on the task. This may be done by sending the identified contributors an invitation to work on the task. The invitation can be a notification sent within crowdsourcing platform 100, a notification shown in a platform (e.g., a website) affiliated with and/or linked to crowdsourcing platform 100, a message sent via a messaging application, an email, etc. In the example shown, recruiter 108 uses network 112 to reach contributors 114. In various embodiments, contributors 114 are a pool of available contributors distributed across the world. In various embodiments, recruiter 108 concurrently recruits for multiple tasks associated with distinct profile configurations.

Each of profiler 104, monitor 106, recruiter 108, and predictor 110 may be any hardware or software system, component, process, and/or application. Each of profiler 104, monitor 106, recruiter 108, and predictor 110 may be co-located or remote via a public, private or hybrid network and may be running on one or more back-end systems where crowdsourcing platform 100 is situated or on one or more front-end systems used by task requesters and contributors. For example, monitor 106 may reside between and connected to network 112 and contributors 114. In various embodiments, the implementation of contributor recruitment component 102 includes at least one microprocessor subsystem (also referred to as a processor or a central processing unit (CPU)). For example, contributor recruitment component 102 can be implemented by a single-chip processor or by multiple processors. In some embodiments, a general-purpose digital processor that controls the operation of contributor recruitment component 102 is used. In various embodiments, profiler 104, monitor 106, recruiter 108, and predictor 110 are implemented on a processor coupled to a memory. The processor is coupled bi-directionally with the memory, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on the processor. Also, as is well known in the art, primary storage typically includes basic operating instructions, program code, data, and objects used by the processor to perform its functions (e.g., programmed instructions). The memory can include any suitable computer readable storage media. The processor can also directly and very rapidly retrieve and store frequently needed data in a cache memory. Mass storage may be used to provide additional data storage capacity for contributor recruitment component 102 and is coupled either bi-directionally (read/write) or uni-directionally (read only) to the processor. For example, mass storage can include computer readable media such as flash memory, portable mass storage devices, and other storage devices. Mass storage generally stores additional programming instructions, data, and the like that typically are not in active use by the processor. It will be appreciated that the information retained within mass storage can be incorporated, if needed, in standard fashion as part of the memory (e.g., RAM) as virtual memory.

In the example shown in FIG. 1, network 112 connects contributor recruitment component 102 with contributors 114. The contributors can be users of crowdsourcing platform 100 and log into the platform to perform tasks. Contributors can be users of other online platforms that connect to crowdsourcing platform 100 (e.g., via application programming interfaces). As described above, contributors can be software agents. Examples of network 112 include one or more of the following: a direct or indirect physical communication connection, mobile communication network, Internet, intranet, Local Area Network, Wide Area Network, Storage Area Network, and any other form of connecting two or more systems, components, or storage devices together. In the example shown, portions of the communication path between the components are shown. Other communication paths may exist, and the example of FIG. 1 has been simplified to illustrate the example clearly. For example, crowdsourcing platform 100 is also typically connected to a network. Although single instances of components have been shown to simplify the diagram, additional instances of any of the components shown in FIG. 1 may exist. The number of components and the connections shown in FIG. 1 are merely illustrative. The components are not necessarily located in the same geographic location. For example, contributor recruitment component 102 does not need to be in the same geographic location as contributors 114. Components not shown in FIG. 1 may also exist.

FIG. 2 illustrates examples of profile configurations used in some embodiments. In the example shown in FIG. 2, the profile configurations are visualized as radar charts. Each radar chart shown represents diversity objectives with respect to features. In the example shown, each feature is represented as a spoke in a radar chart, and diversity is represented by spoke length. In the example shown, data extending all the way to a vertex represents maximal (i.e., 100%) diversity of a feature. For example, in radar chart 2, gender, age, and country (of origin) spokes extend to vertices, indicating maximal gender, age, and country (of origin) diversity are desired for a task whose profile configuration is visualized as radar chart 2. In radar chart 2, language, experience, and skills spokes extend halfway to vertices, indicating maximal language, experience, and skills diversity are not desired for the task. Spokes extending halfway does not necessarily indicate 50% diversity; spoke length indicates a relative prioritization for one objective among multiple objectives (e.g., a spoke extending halfway indicates the objective represented by the spoke is relatively less important than an objective represented by a full length spoke and relatively more important than an objective represented by a spoke of zero length). In various embodiments, diversity is associated with a distribution of contributors. Maximal (i.e., 100%) diversity indicates a uniform distribution of a feature among contributors. For example, maximal gender diversity corresponds to a uniform gender distribution (i.e., half male contributors and half female contributors). In various embodiments, radar chart profile configurations are converted to numerical form for use by contributor recruitment component 102 of FIG. 1. For example, a list of percentages, where each percentage corresponds to a requirement in diversity for a feature in a radar chart, may be used. In some embodiments, entropy is used to describe diversity objectives. For example, a gender diversity of 100% (i.e., a uniform gender distribution) is the equivalent of a gender entropy of 1. In this example, for a gender distribution of x, entropy H(x) of the gender distribution can be defined as:

$$H ( x ) = {\sum }_{i = 1}^{2} {p}_{i} {log}_{2} ( \frac{1}{{p}_{i}} ) \qquad ( 1 )$$

where p₁ and p₂ are probabilities (in this case, percentages) corresponding to male and female contributors.

When p₁=p₂=0.5 (i.e., 50%), H(x)=½ log₂ 2+½ log₂ 2=½+½=1. As is well known in the art, entropy is readily generalizable to probability distributions in which an arbitrary number of probabilities exists

$$( e . g . , H ( x ) = {\sum }_{i = 1}^{N} {p}_{i} {log}_{N} ( \frac{1}{{p}_{i}} ) ) ,$$

as well as to continuous probability distributions. In various embodiments, entropies of distributions other than gender are used (e.g., age, language, and country (of origin)). For any distribution, an entropy of 1 corresponds to maximal diversity. The maximum entropy (maximal diversity) is 1 because entropy has been normalized (entropy with log base N where N is the number of distinct categorical values for which a probability distribution is calculated). In some embodiments, the SciPy library is used to compute the entropy. Metrics other than entropy may also be used to describe diversity objectives.

In the radar charts shown in FIG. 2, the features shown are gender, age, language, country (of origin), experience, and skills. Gender, age, language, and country (of origin) are basic traits/attributes that every human contributor has. Experience is a flexible feature and can be measured using various metrics. It may, for example, be associated with how many tasks a contributor has worked on in the past. Skills is another flexible feature. It may, for example, be associated with types of tasks (e.g., audio transcription, photo annotation, content moderation, and relevance judgment) in which a contributor is proficient and/or has significant experience with. Proficiency may be measured by a contributor's historical accuracy associated with a task (e.g., word accuracy in the case of audio transcription). In some embodiments, diversity of demographic groups is also an objective. For example, if 10-20, 20-30, 30-40, and 40-50 years old are age demographic groups, a goal may be to recruit from the most distinct number of groups as possible. For some tasks, a specific distribution of contributors is needed in order to achieve contributions without substantial bias. For example, with content moderation, if all contributors are 20-year-old white males from the United States, the definition of what explicit content means will likely be different than what it would mean with a more balanced panel of contributors. The radar charts shown in FIG. 2 show different desired feature configurations for different tasks. For example, radar chart 2 could be for a photo annotation task in which gender, age, and country (of origin) diversity are considered important, therefore the corresponding spokes extend to vertices to indicate maximal diversity. In some embodiments, diversity objectives for features are supplied by a requestor of a task and configured using a user interface that allows the requester to adjust the individual spokes of the radar chart. In some embodiments, default and/or recommended diversity objectives for features are used. Diversity objectives for features may be determined without input from a requestor. For example, by looking at a distribution of answers for different types of tasks, features for which balanced distributions are desirable can be determined (e.g., if answers provided by male and female contributors for content moderation tasks are very different, then a conclusion can be drawn that a fair balance between males and females for a particular content moderation task is desirable). In various embodiments, features not shown in radar charts are also used in profile configurations. Examples of these features include continuous variables such as contributor hourly wage and historical accuracy and number of contributors desired for a task.

In embodiments in which software contributors are recruited, profile configurations include features specific to software contributors. In some embodiments, software contributor biases are included in profile configurations. In various embodiments, software contributors utilize models trained to perform tasks that human contributors perform. These models, and thus the software contributors, may have biases in a manner similar to how human contributors have biases. For example, if a software contributor's face recognition model is trained on data sets comprising predominantly Caucasian faces, then the software contributor may have a Caucasian bias (e.g., it might make more errors when it encounters non-Caucasian faces). Biases may be determined by examining training data. For example, if data sets used to train models were labeled by contributor groups having skewed gender, age, or country of origin distributions, then the models may have gender, age, or country of origin biases in a manner similar to gender, age, or country of origin biases of groups of human contributors. Biases of models may be measured, for example, by comparing answers given by the models to answers given by groups of human contributors having balanced distributions for specified features. For example, a model might have a gender bias if the answers the model gives are significantly different from those given by groups of human contributors having balanced gender distributions. In some embodiments, software contributor biases are formulated in terms of performance with respect to specific tasks. For example, a model has a content moderation bias if it tends to rate pieces of text as offensive at a higher rate than human contributors and other software contributors. In some embodiments, a feature of software contributors included in profile configurations is the overall model used by a software contributor. In some embodiments, this overall model encapsulates all of the model's attributes (e.g., biases with respect to various tasks, accuracy with respect to various tasks, and other attributes). In some embodiments, profile configurations specify diversity objectives for models. For example, a profile configuration might specify high model diversity, indicating that dividing up work among 10 different models might be more desirable than using a single model for the work. Model diversity may be measured, for example, by using an entropy metric, as described above. The amount of work (e.g., the percentage of work needed to complete a task) to be performed by software contributors versus human contributors may also be a feature in profile configurations.

In some embodiments, characteristics of contributions are features that are included in profile configurations. For example, for a task in which pieces of text are read by contributors to produce audio samples, background noise of audio samples is a characteristic of contributions made by the contributors. A corresponding feature that may be tracked for contributors is the rate at which a contributor provides audio samples with background noise. A profile configuration may specify diversity in background noise (e.g., specify that half of audio samples should include background noise above a threshold level and the other half should include background noise below the threshold). In various embodiments, characteristics of contributions are automatically detected by contributor recruitment component 102 of FIG. 1. In the audio sample example, background noise could be detected automatically as contributions are received, and the proportion of audio samples with background noise could be monitored and adjusted (e.g., if too many audio samples received from contributors do not include background noise, then more contributors that tend to produce audio samples with background noise could be recruited by recruiter 108 of FIG. 1). Similarly, language-related accent is another example of a characteristic that can be automatically detected and diversified by recruiting contributors with a wider range of accents.

Features that may be included in profile configurations, whether for human contributors or software contributors, are not limited to the examples described herein. The examples of profile configuration features described herein are illustrative and not restrictive.

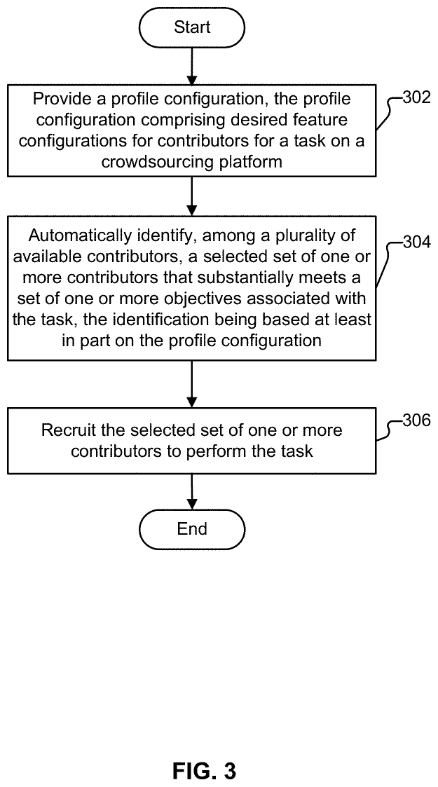

FIG. 3 is a flow chart illustrating an embodiment of a process for recruiting contributors in accordance with a profile configuration. In some embodiments, the process of FIG. 3 is implemented in contributor recruitment component 102 of FIG. 1.

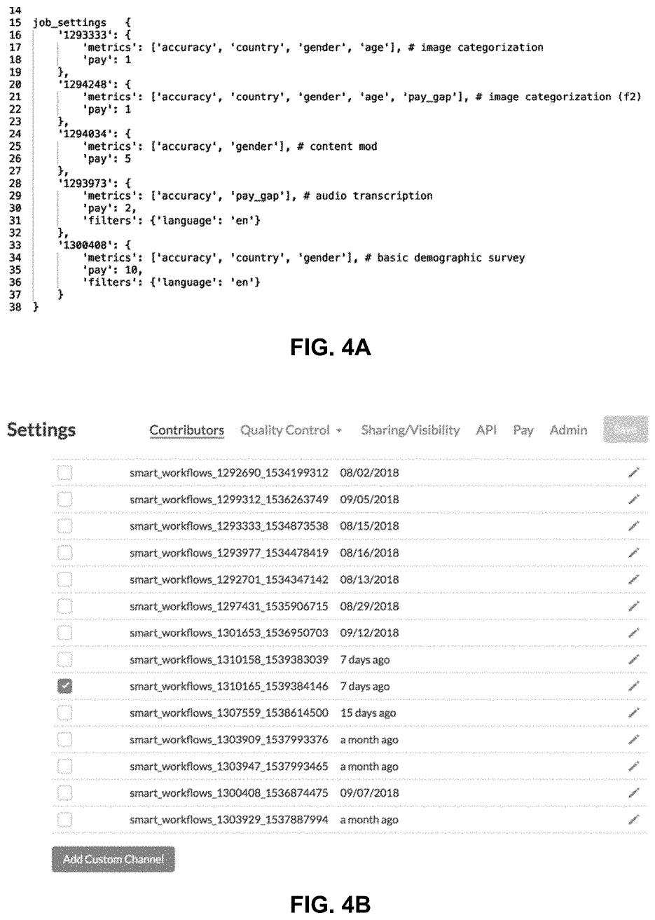

At 302, a profile configuration (the profile configuration comprising desired feature configurations for contributors for a task on a crowdsourcing platform) is provided. In some embodiments, the profile configuration is provided by profiler 104. In some embodiments, the profile configuration has desired feature configurations that can be visualized in a radar chart. Desired feature configurations may exist for features including gender, age, language, country of origin, experience, skills, historical accuracy as measured from prior work (e.g., as related to specific tasks, such as audio transcription and image classification), hourly wage, and number of contributors. Other characteristics of contributors that may be included in profile configurations include occupation, education level, marital status, etc. As shown in FIG. 4A and described below, each task has a profile configuration. In some embodiments, the profile configuration for the task is created by a requestor of the task. For example, a requestor of the task may create a radar chart profile configuration. Stated differently, the profile configuration may be created manually. The profile configuration may also be created automatically. For example, an appropriate profile configuration for a task may be created based on comparing the task to prior similar tasks and using a profile configuration similar to those of the prior similar tasks.

At 304, among a plurality of available contributors, a selected set of one or more contributors that substantially meets a set of one or more objectives associated with the task is automatically identified (the identification being based at least in part on the profile configuration). An example set of contributors in list form is shown in FIG. 4B. The identification of a set of one or more contributors to recruit for a task depends at least in part on the profile configuration for the task. For example, if the profile configuration specifies a uniform gender distribution, then one of the objectives in recruiting contributors from a pool of available contributors (taking into account those who have already worked on the task) for the task is a balanced recruitment of males and females. Because a profile configuration typically specifies more than one feature, it is oftentimes not possible to completely satisfy all objectives (or even completely satisfy any single objective) specified in the profile configuration. For example, if one objective is balanced gender recruitment and another simultaneous objective is balanced recruitment according to age, it might not be possible to completely satisfy both objectives if the pool of available contributors is such that all males are old and all females are young. Therefore, oftentimes, a selected set of one or more contributors that substantially meets (instead of completely satisfying) a set of one or more objectives is identified. As described in detail below, in various embodiments, multi-objective optimization is performed to identify a set of one or more contributors that substantially meets a set of one or more objectives and/or outperforms other sets of one or more contributors with respect to meeting objectives specified in a profile configuration.

At 306, the selected set of one or more contributors is recruited to perform the task. In various embodiments, recruitment corresponds to soliciting the selected contributors to work on the task. This may be done by sending human contributors an invitation to work on the task. Human contributors invited to work on the task may not accept the invitation. In various embodiments, contributor recruitment component 102 of FIG. 1 monitors task progress by tracking contributors that have accepted an invitation to work on each particular task. If the number of contributors that are working or have worked on a task is insufficient, more contributors may be recruited until a sufficient number has worked on the task.

FIGS. 4A-4B are example visual representations of significant steps in an embodiment of a process for recruiting contributors in accordance with a profile configuration. FIG. 4A shows source code defining profile configurations for several tasks. As shown in FIG. 4A, each task, as identified by a task identification number, has its own profile configuration. The features in any particular profile configuration may vary according to the type of task. FIG. 4B shows a grouping of identified contributors that substantially meets a set of one or more objectives specified in a profile configuration. As shown in FIG. 4B, each contributor is identified by a contributor identification number. In some embodiments, contributors are informed that their contributions are requested. In various embodiments, contributors that are recruited are not aware that they are part of a set of one or more contributors that substantially meets a set of one or more objectives specified in a profile configuration. This knowledge is kept from contributors because knowledge of targeted recruitment might be a source of bias for contributors when working on a task. In various embodiments, it will appear to contributors that they are receiving requests to work on tasks in a manner identical to how they have received requests to work on tasks that do not have profile configurations. In some embodiments, contributors are informed that they are part of a set of one or more contributors that substantially meets a set of one or more objectives specified in a profile configuration (e.g., when the effects of such knowledge are clear and measurable, such sharing could be included).

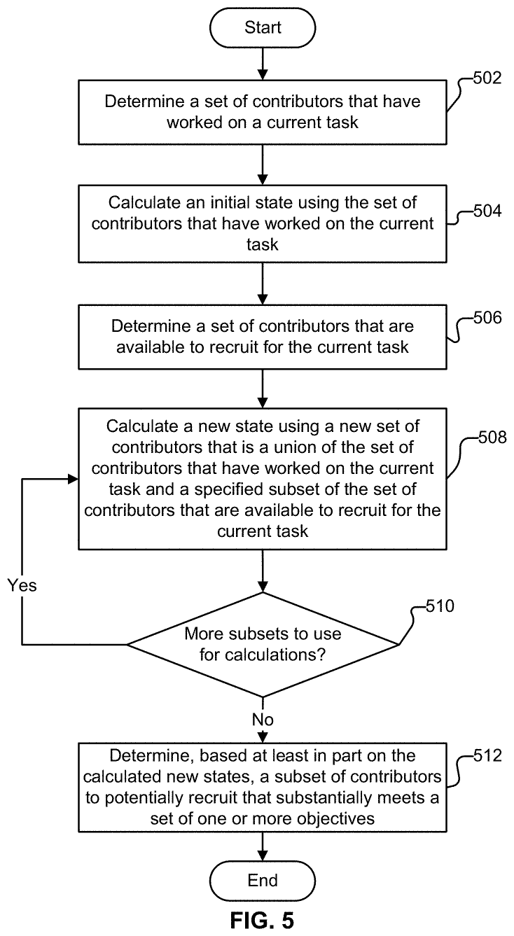

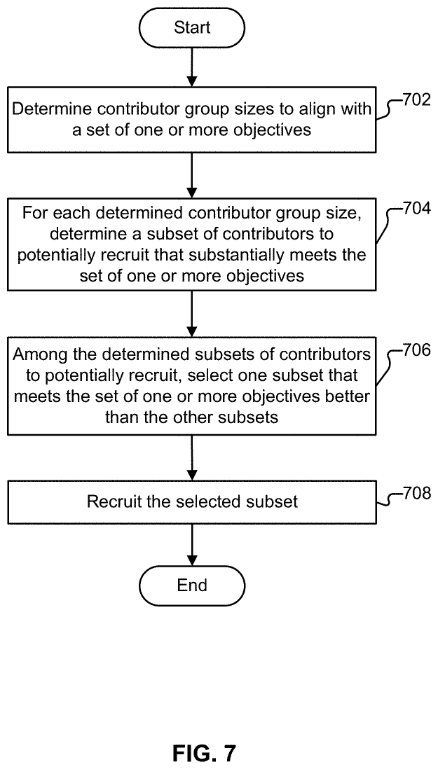

FIG. 5 is a flow chart illustrating an embodiment of a process for identifying a set of contributors that substantially meets a set of one or more objectives. In various embodiments, the objectives are desired feature configurations specified in a profile configuration. Examples of objectives include diversity objectives (e.g., with respect to features such as gender, age, and country of origin), objectives associated with accuracy, objectives associated with hourly wage, and objectives associated with having a specified number of contributors. Having a specified number of contributors may be associated with achieving a specified throughput for a task. In some embodiments, the process of FIG. 5 is implemented in contributor recruitment component 102 of FIG. 1. In some embodiments, at least a portion of the process of FIG. 5 is performed in 304 of FIG. 3 and/or 704 of FIG. 7.

At 502, a set of contributors that have worked on a current task is determined. This set may include both contributors currently working on the current task that have not finished their work and contributors that have worked on the current task and have finished their work. In some embodiments, the set of contributors that have worked on a current task is determined by monitor 106 of FIG. 1.

At 504, an initial state using the set of contributors that have worked on the current task is calculated. The initial state is calculated using only the set of contributors that have worked on the current task. The initial state is an instance of a state that can be calculated. In various embodiments, each state that is calculated is a set of measurements associated with a set of features associated with a set of contributors. The set of features associated with a calculation of a state for a current task can be obtained from a profile configuration for the current task. For example, suppose that the profile configuration for the current task includes the following features: gender, age, and country (of origin). In this case, if the features of gender, age, and country (of origin) are characterized as entropies in the profile configuration, then the initial state calculated for the set of contributors that have worked on the current task would be gender, age, and country (of origin) entropies of the gender, age, and country (of origin) distributions, respectively, of the set of contributors that have worked on the current task. Each state that is calculated can be compared with a profile configuration associated with the calculation of the state. In the above example involving a profile configuration including gender, age, and country (of origin) as features, if uniform distributions for gender, age, and country (of origin) are desired, the profile configuration would read {gender entropy=1; age entropy=1; country entropy=1}. In this example, an initial state that is calculated using entropy equations such as equation (1) and variations of equation (1) might be {gender entropy=0.8; age entropy=0.7; country entropy=0.3} (or whatever results from the set of contributors that have worked on the current task). In various embodiments, calculation of states is performed by recruiter 108 of FIG. 1. Features calculated from a state can also be an aggregate function (e.g., mean, number of distinct countries of contributors in a candidate set, etc.). For example, a mean historical accuracy objective may be set in the background (not necessarily via a profile configuration).

At 506, a set of contributors that are available to recruit for the current task is determined. The set of contributors that are available to recruit for the current task is the pool of available contributors (e.g., contributor users that are currently logged onto crowdsourcing platform 100 and/or any affiliated platform, have logged onto the platform within a certain time window, etc.) that can be solicited to work on the current task. In some embodiments, contributors that are offline may be deemed available (e.g., if they can be contacted and can respond to a recruitment request). In various embodiments, available contributors are distributed across the world and accessible via a network.

At 508, a new state using a new set of contributors that is a union of the set of contributors that have worked on the current task and a specified subset of the set of contributors that are available to recruit for the current task is calculated. Stated differently, the new state is calculated using an updated set that includes the set of contributors that have worked on the current task and a subset of the pool of available contributors that can be solicited to work on the current task.

For example, if there are 5 contributors that have worked on the current task and there are 10 available contributors that can be solicited, a possible new set of contributors for which to calculate a new state is a set of contributors that includes the 5 contributors that have worked on the current task plus one of the 10 available contributors. In this example, any combination of a single available contributor, 2 available contributors, 3 available contributors, and so forth up to 10 available contributors may be added to the 5 contributors that have worked on the current task to form a new set for which a new state is calculated. If no contributors have worked on the current task (e.g., recruiting has not commenced), then the set of contributors that have worked on the current task is an empty set, in which case, the embodiment of the process illustrated in FIG. 5 is still applicable (e.g., the union of an empty set and another set is that other set). FIG. 5 contemplates calculating new states in association with adding a specified number of contributors from the pool of available contributors. Contributors may be added on a one-by-one basis. In some embodiments, the specified number of contributors added is a percentage of the pool of available contributors. For example, new sets could be formed by adding 20% of the available contributors to the contributors that have worked on a current task. In the example with 10 available contributors, this would correspond to 2 contributors, and new states would be calculated for sets in which different combinations of 2 contributors out of 10 available contributors are added to the 5 existing contributors (ones that have already worked on the current task). In the example with 2 out of 10 available contributors added to 5 existing contributors, each new state includes feature values that are updated in light of adding 2 additional contributors. In this example with 2 out of 10 available contributors added to 5 existing contributors, if the profile configuration for the current task included gender entropy, age entropy, and country entropy, then gender, age, and country entropies would be re-calculated for new sets of 7 contributors (2 additional contributors added to the 5 existing contributors).

At 510, it is determined whether there are more subsets to use for calculations of states resulting from sets that are unions of the set of contributors that have worked on the current task and specified subsets of the set of contributors that are available to recruit for the current task. If at 510 it is determined that there are more subsets to use for calculations, then step 508 is repeated. Otherwise, step 512 is performed. In the example above with 2 out of 10 available contributors added to 5 existing contributors, more subsets to use for calculations corresponds to more combinations of 2 available contributors to add. In some embodiments, all or substantially all combinations of a specified number of contributors to add are used to calculate new states.

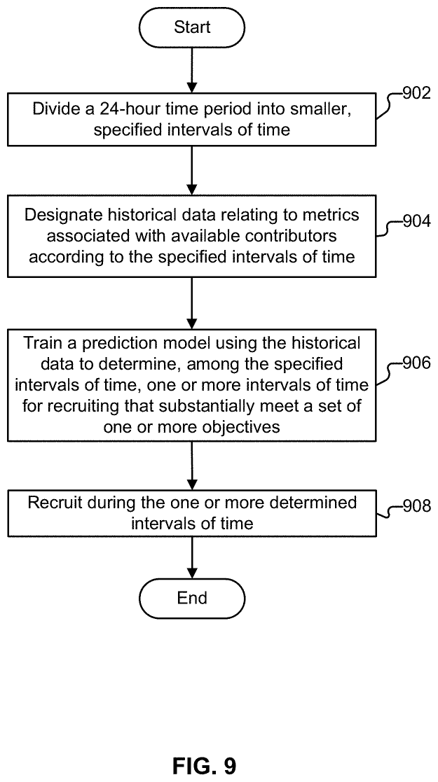

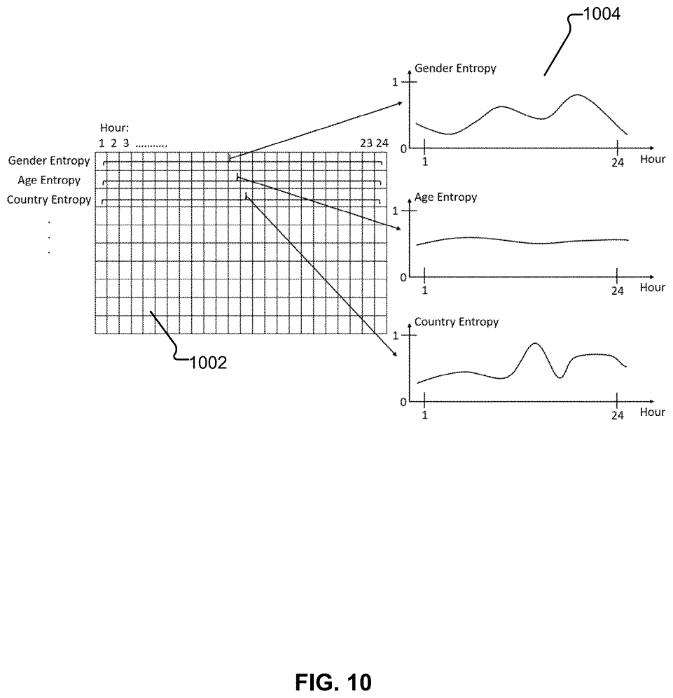

At 512, based at least in part on the calculated new states, a subset of contributors to potentially recruit that substantially meets a set of one or more objectives is determined. In the example above with 2 out of 10 available contributors added to 5 existing contributors, a specific subset of 2 out of the 10 available contributors is identified as a potential group to recruit for the current task. The specific subset of contributors to potentially recruit is determined based at least in part on determining which subset's state substantially meets one or more objectives specified in the profile configuration. Sets with different contributors result in different feature values for states (e.g., different gender, age, and country entropies). For example, sets in which all male contributors are added to a set of existing contributors that is already all male would result in lower gender entropy. Adding female contributors to a set of existing contributors that is all male would increase gender entropy. If one of the objectives specified in the profile configuration is high gender entropy (e.g., gender entropy=1), then a subset whose state is characterized by high gender entropy may be a good candidate for selection. Because profile configurations often include more than one feature, several state characteristics are often considered at the same time. For example, if high gender, age, and country entropies are specified in the profile configuration, a subset whose state is characterized by age, gender, and country entropies in a manner that substantially meets the gender, age, and country entropy objectives better than other subsets could be a good candidate for selection. Timing for recruitment is described in further detail herein (e.g., see FIGS. 9 and 10). In various embodiments, a multi-objective optimization is performed to identify which state (based at least in part on a subset of contributors to potentially recruit and contributors that are currently working on or have already worked on the task) substantially meets the set of one or more objectives better than other subsets. In some embodiments, the Python Parallel Global Multiobjective Optimizer (PyGMO) is used to perform multi-objective optimization. FIG. 5 illustrates one example of a multi-objective optimization process. This example description is illustrative and not restrictive. Other processes may be used to identify a group of contributors that substantially meets a set of one or more objectives (e.g., other ways to calculate and handle states associated with contributors may be used to determine which contributors to potentially recruit).

In some embodiments, the multi-objective optimization produces pareto-optimal results in the sense that improvements for one feature (e.g., gender entropy) come at the cost of another feature (e.g., age entropy). In various embodiments, performing multi-objective optimization involves determining an objective function to maximize. In the example above where gender, age, and country entropies are specified in the profile configuration, a possible objective function is an unweighted sum of gender, age, and country entropies. Determining a state that maximizes or is substantially close to the maximum of the unweighted sum of gender, age, and country entropies in this example is the multi-objective optimization problem to be solved. In some embodiments, PyGMO methods that deal with choosing pareto-optimal portions of a population are used. In some embodiments, the multi-objective optimization considers likelihoods of individual contributors accepting tasks and/or completing tasks (e.g., in a prediction model based on historical records associated with contributors). Aggregate metrics (e.g., mean of historical accuracy) may also be considered.

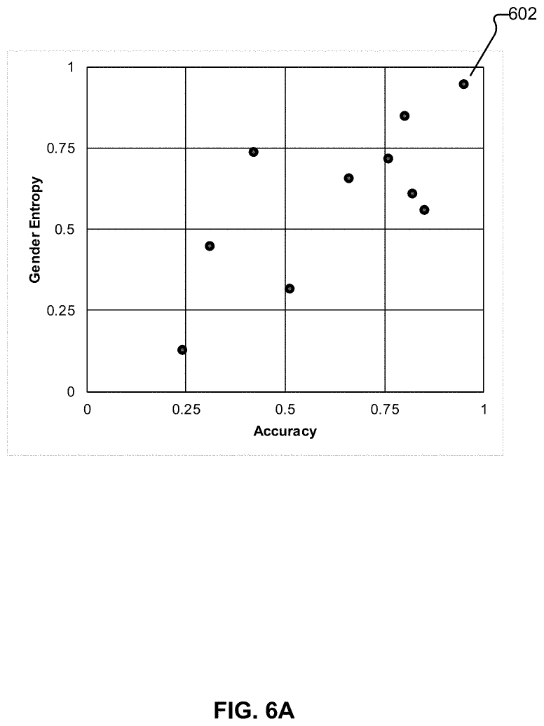

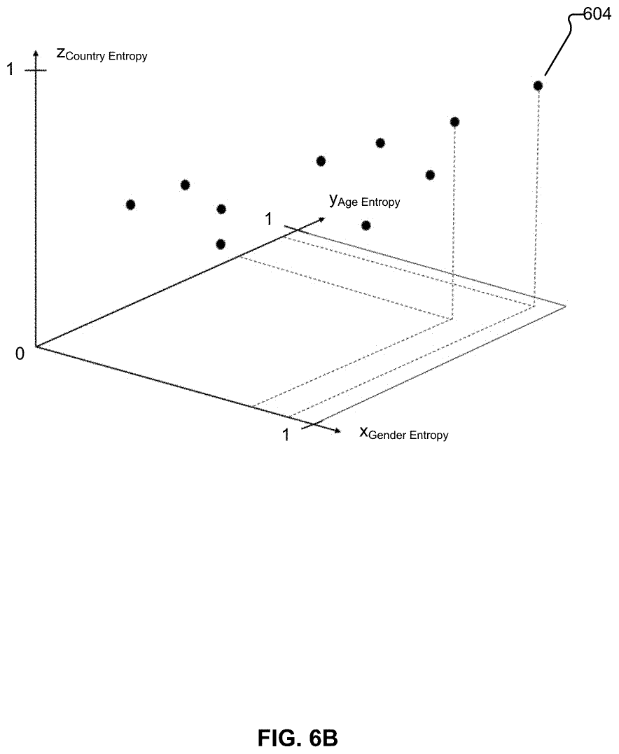

FIG. 6A and its accompanying description provide a simple two-objective (i.e., two-dimensional) optimization for illustrative purposes. As one skilled in the art can readily appreciate, the optimization illustrated in FIG. 6A is generalizable to multi-objective optimizations in which more than two dimensions exist. In some embodiments, the objective function is formulated as a cost function to minimize. In some embodiments, the objective function is a weighted sum of components in which the weight assigned to each component in the objective function corresponds to the relative importance of that component (e.g., if having high gender entropy is more important than having high age entropy for a particular task, then gender entropy can be weighted more than age entropy).

FIG. 6A is a diagram illustrating an example of a multi-objective optimization. The example shown in FIG. 6A is associated with a profile configuration in which two objectives are specified: 1) gender entropy=1 and 2) accuracy=1 (i.e., 100%). In this example, accuracy corresponds to historical accuracy of contributors. Suppose that each point shown in FIG. 6A corresponds to a subset of contributors to potentially recruit (and already recruited) from a pool of available contributors. In the example shown, each point's x-axis extent corresponds to an overall (e.g., average) accuracy calculated for a set of contributors comprising the subset of contributors associated with the point (contributors to potentially recruit and already recruited). Furthermore, in the example shown, each point's y-axis extent corresponds to an updated gender entropy calculated for a set of contributors comprising the subset of contributors (contributors to potentially recruit and already recruited) associated with the point. In this example, in order to satisfy the two objectives of maximal gender entropy and maximal accuracy, a point is chosen that substantially meets both objectives. In the example shown, no point completely satisfies both objectives because no point rests at the coordinate (1,1). In various embodiments, a point that substantially meets objectives better than other points is a point closest to a point representing an ideal case. In this example, (1,1) is a point representing an ideal case (ideal case of maximal accuracy and gender entropy). In this example where (1,1) is the ideal case, a distance metric/formula such as d=\sqrt{(x−1)²+(y−1)²} may be used (where d is the calculated distance from (1,1), x is the x-coordinate of a point to be evaluated, and y is the y-coordinate of the point to be evaluated). In the example shown, the point closest to (1,1) is the point closest to the upper-right corner of the diagram, point 602. In this example, the subset of contributors (contributors to potentially recruit and already recruited) associated with that point would be identified. As one skilled in the art can readily appreciate, the distance metric/formula described above is generalizable to cases in which more than two dimensions exist.

FIG. 6B is a diagram illustrating an example of a three-dimensional optimization. FIG. 6B illustrates how the distance metric/formula used in the two-dimensional example illustrated in FIG. 6A can be generalized to three dimensions. In the example shown, the x, y, and z axes represent gender, age, and country entropies, respectively. The example shown in FIG. 6B is associated with a profile configuration in which three objectives are specified: gender entropy=1, age entropy=1, and country entropy=1. Each point shown in FIG. 6B corresponds to a subset of contributors (contributors to potentially recruit and already recruited) to select. In the example shown, each point's x-axis extent corresponds to an updated gender entropy calculated for a set of contributors (contributors to potentially recruit and already recruited) to select. Similarly, in the example shown, each point's y-axis extent corresponds to an updated age entropy calculated for a set of contributors comprising the subset of contributors associated with the point and the set of existing contributors, and each point's z-axis extent corresponds to an updated country entropy calculated for a set of contributors comprising the subset of contributors associated with the point and the set of existing contributors. In the example shown, no point completely satisfies all three objectives because no point rests at the coordinate (1,1,1). In this example where (1,1,1) is the ideal case, a distance metric/formula such as d=\sqrt{(x−1)²+(y−1)²+(z−1)²} may be used (where d is the calculated distance from (1,1,1), x is the x-coordinate of a point to be evaluated, y is the y-coordinate of the point to be evaluated, and z is the z-coordinate of the point to be evaluated). In the example shown, the point closest to (1,1,1) is the point closest to the upper-right corner of the diagram, point 604. In this example, the subset of contributors associated with that point would be identified as a subset of contributors to potentially recruit.

FIG. 7 is a flow chart illustrating an embodiment of a process for recruiting a subset of contributors from candidate subsets of different sizes. In some embodiments, the process of FIG. 7 is implemented in contributor recruitment component 102 of FIG. 1. In some embodiments, at least a portion of the process of FIG. 7 is performed in 304 of FIG. 3.

At 702, contributor group sizes that align with a set of one or more objectives are determined. As shown in FIG. 5 and its accompanying description, a subset of contributors to potentially recruit that substantially meets a set of one or more objectives can be determined for a specified contributor group size. In various embodiments, it is desirable to compare target sets of contributors of various sizes to identify a single subset that substantially meets a set of one or more objectives better than the other subsets. For example, in the example where there are 10 available contributors (see description accompanying FIG. 5), it might be desirable to compare various subsets of 1, 2, 3, . . . 8, 9, and 10 contributors to identify a single subset that substantially meets a set of one or more objectives better than the other subsets. In some embodiments, particularly if the pool of available contributors is large, it is not desirable to perform comparisons for subsets of every possible size due to a high computational cost of doing so. For example, if there are 1000 available contributors, it might not be desirable to identify for every contributor group size (1, 2, 3 . . . 998, 999, 1000) a subset that substantially meets a set of one or more objectives, as this might entail performing a multi-objective optimization for 1000 different contributor group sizes, which might not be computationally feasible. In some embodiments, a sampling of contributor group sizes is selected instead. For example, in the case of 1000 available contributors, contributor group sizes of 5%, 10%, 15%, . . . 90%, 95%, and 100% of the number of available contributors (i.e., sizes of 50, 100, 150, . . . 900, 950, and 1000 contributors for the case of 1000 available contributors) may be selected such that a multi-objective optimization is performed only for these contributor group sizes. In some embodiments, optimization states are computed by adding contributors on a one-by-one basis (and the best 5%, 10%, . . . 95%, 100% of available contributors are selected).

At 704, for each determined group size, a subset of contributors to potentially recruit that substantially meets the set of one or more objectives is determined. In some embodiments, the subset of contributors of that determined group size to potentially recruit (not already recruited) that substantially meets the set of one or more objectives is determined using an embodiment of a process illustrated in FIG. 5. Stated differently, in various embodiments, a multi-objective optimization (e.g., a multi-objective optimization as shown in FIG. 5 and its accompanying description) is repeated for more than one contributor group size, resulting in multiple subsets of contributors that substantially meet a set of one or more objectives specified in a profile configuration.

At 706, among the determined subsets of contributors to potentially recruit, one subset that meets the set of one or more objectives better than the other subsets is selected. In some embodiments, PyGMO methods that deal with pareto-optimization are used to select a subset that meets the set of one or more objectives better than the other subsets. In various embodiments, each determined subset is associated with a state that can be compared with a profile configuration that specifies one or more objectives to meet. For example, gender, age, and country entropies equal to one can be specified in the profile configuration, and, in this case, each subset's state would be characterized by age, gender, and country entropies. In some embodiments, states of the subsets are compared with the profile configuration by using a distance metric/formula, and a state that is closer to the profile configuration than other states is determined. In the example above involving gender, age, and country entropies, distances between points in a three-dimensional space can be calculated, and a subset that meets the set of one or more objectives better than other subsets is a subset whose associated point in a gender/age/country entropy three-dimensional space is closest to a point representing gender, age, and country entropies of value one (as is shown in FIG. 6B).

At 708, the selected subset is recruited. In various embodiments, recruitment corresponds to soliciting contributors that are members of the subset to work on a task via messages, emails, etc. In some embodiments, if it is desirable to complete a task quickly, it is desirable to recruit as many contributors as possible during each recruitment of contributors. Promoting recruitment of more contributors during each recruitment of contributors may be accomplished by including contributor group size as a feature in the profile configuration and specifying a large contributor group size as an objective.

Subsequently, in various embodiments, the recruited contributors perform the task and the results are recorded. In some embodiments, the output of contributors is used to predict contributor availability and/or is used by requestors of tasks for various purposes (e.g., as training data for artificial intelligence models).

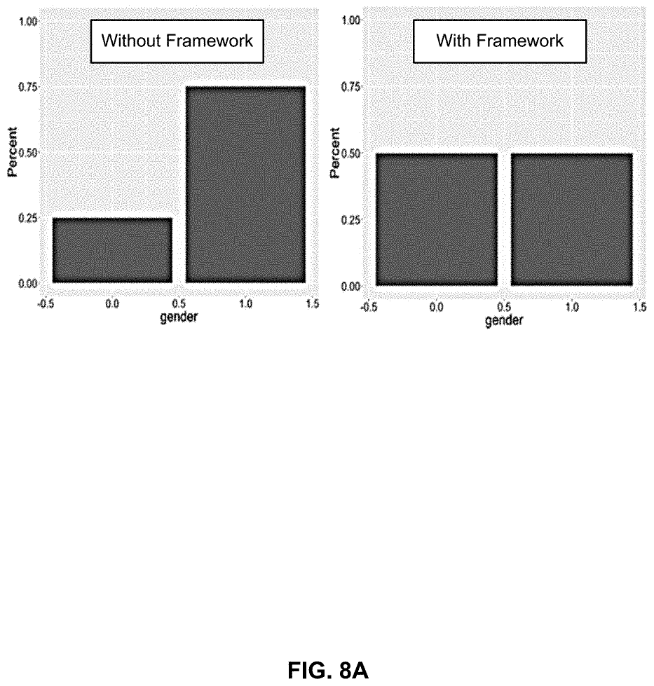

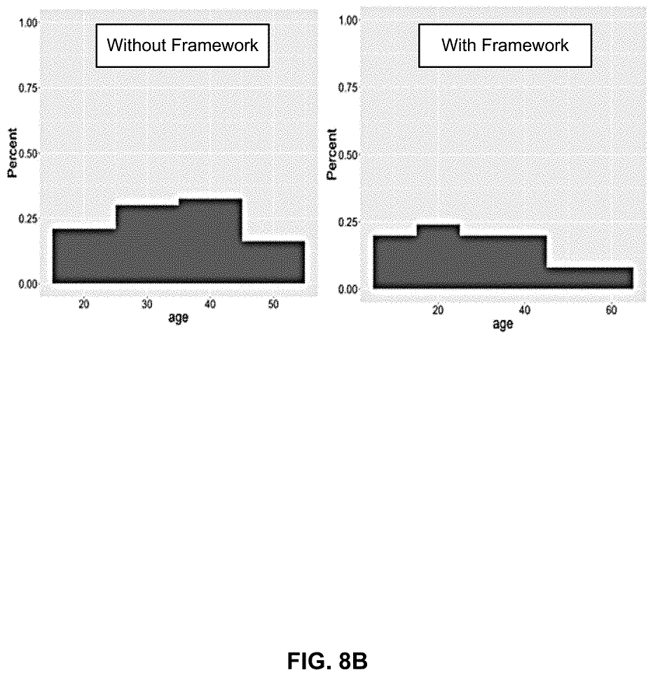

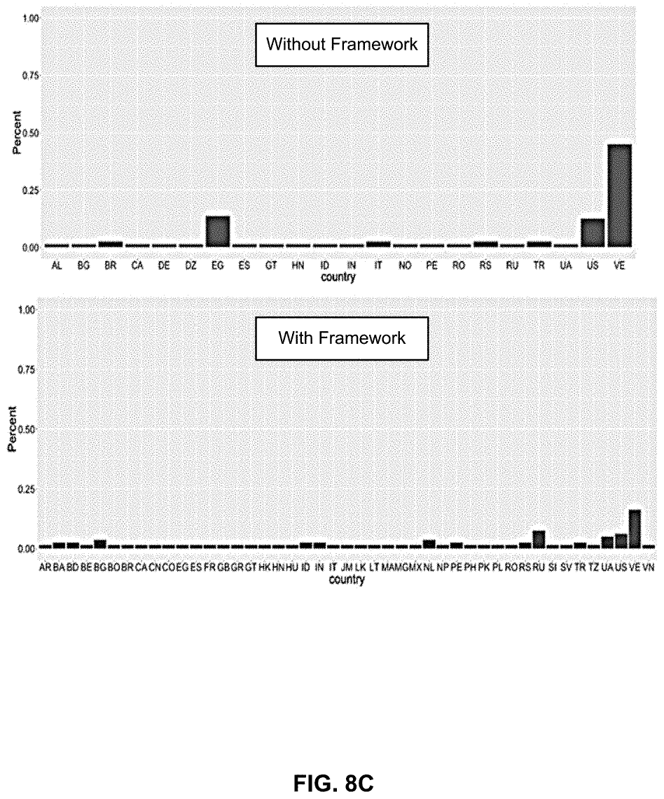

FIGS. 8A-8C illustrate examples of distributions of specific features related to contributors for a specific task, without and with a framework for recruiting contributors to meet objectives specified in a profile configuration. FIGS. 8A-8C are examples of how more balanced distributions with respect to specific features can be achieved when recruiting is performed with balanced distributions as objectives. The “With Framework” charts in FIGS. 8A-8C show more balanced gender, age, and country distributions than the “Without Framework” charts. In the example shown in FIG. 8A, gender went from a 75%/25% distribution to an even 50%/50% split. Furthermore, age diversity increased, as shown in FIG. 8B. In addition, in the example shown in FIG. 8C, country (of origin) diversity increased substantially, which might mirror the diversity in an actual user base of a product that could ultimately rely on the contributions provided by the contributors.

FIGS. 8A-8C illustrate several benefits associated with the invention. One important aspect of the invention is the ability to control compositions of groups of contributors working on tasks, allowing for the enforcement of relative proportions of certain categories of people, as defined by information volunteered by contributors (e.g., traits such as age, gender, and country of origin) as well as secondary factors that can be computed from historical data related to contributors (e.g., historical accuracy associated with certain tasks). Traits may also be predicted. For example, if a specific contributor is working on a crowdsourcing task that requires the contributor to write reviews and/or make judgments associated with pieces of politics-related data and the contributor leaves negative reviews primarily for certain types of politics-related data, it is possible to identify/predict the contributor's political affiliation. No trait is precluded from appearing in a profile configuration provided that there is sufficient data to create a prediction. A benefit of using a framework to control compositions of groups of contributors (e.g., according to specified traits) is that the framework can be used to lower biases caused by disproportionate distributions in specific traits. For example, with respect to content moderation, if all contributors are male, the definition of what explicit content means will likely be biased towards what males (as opposed to females) consider explicit, which can be different from what the general user population considers as explicit. The framework can also be leveraged when annotating data, or collecting new data from scratch (e.g., in the case of utterance collection). For example, compositions of groups of contributors working on annotation tasks (e.g., audio/video/photo/other data annotation) can be controlled to reduce bias in labels attached to audio/video/photo/other data. Similarly, compositions of groups of contributors can be controlled for data collection tasks (e.g., utterance collection) in order to achieve diversity in features (e.g., gender, age, language, country, etc.). Therefore, the framework is a flexible framework that not only helps to solve the problem of biases in data labeling, but also in data collection. Thus, the framework promotes the ethical generation of data and overall ethics in artificial intelligence (e.g., users can have access to artificial intelligence applications that include less bias). Additionally, the ethical generation of data is promoted by balancing less obvious features, such as contributor wages. For example, it is possible to use the framework to enforce pay close to minimum wage in various contributor countries to promote fairness towards contributors. A further benefit of promoting ethical generation of data (e.g., by promoting fair wages) is that data quality may improve. For example, promoting fair wages might result in happier, more focused contributors that are able to do higher quality work. It may be specified in a profile configuration that an objective is to have a high ratio of pay to minimum wage (where minimum wage is determined according to a contributor's country).

A further benefit of the framework is flexibility with respect to how traits for which balance is desirable are determined. In some embodiments, determination of traits for which balance is desirable can be done manually by a requestor of a task if the requestor has the ability to define a desirable composition of contributors for a specific task. Determination of traits may also be data-driven. An automated framework may determine traits for which balance is desirable by comparing differences in responses across different populations and determining which traits, when unbalanced, lead to significantly different responses. For example, it is possible to review content moderation tasks and check if differences in answers from men and women are statistically significant (if so, a balanced gender distribution might be desirable).

FIG. 9 is a flow chart illustrating an embodiment of a process for determining when to commence or continue recruiting of contributors. In some embodiments, the process of FIG. 9 is implemented in contributor recruitment component 102 of FIG. 1. In some embodiments, at least a portion of the process of FIG. 9 is performed in 306 of FIG. 3.

At 902, a time period (e.g., 24 hours) is divided into smaller, specified intervals of time. For example, there might be 24 intervals, one corresponding to each hour in a day. The intervals could also be smaller (e.g., 20-minute intervals instead of one-hour intervals) or larger (e.g., 2-hour intervals instead of one-hour intervals). The intervals do not need to be the same duration (e.g., it is possible to have some 20-minute intervals, some one-hour intervals, and some two-hour intervals).

At 904, historical data relating to metrics associated with available contributors is designated according to the specified intervals of time. All features, metrics, and/or traits that can be included in a profile configuration (e.g., those related to gender, age, language, country of origin, historical accuracy, hourly wage, and number of contributors available) are considered. These features, metrics, and/or traits are calculated for contributors available during the specified intervals of time. For example, gender distributions (and thus gender entropies) could be calculated for available contributors during each hour for every day from the past three months.

At 906, a prediction model (e.g., a neural network) is trained using the historical data to determine, among the specified intervals of time, one or more intervals of time for recruiting that substantially meet a set of one or more objectives. For example, historical data in the form of states corresponding to features that can be included in profile configurations with respect to available contributors during one-hour increments could be used as training data. In some embodiments, the training data is used to train a prediction model that includes an LSTM neural network in which the output is a sequence of states. In the example in which one-hour intervals are used for 24 hours, the output of the prediction model (e.g., LSTM neural network) would be 24 sequential states, with each state associated with a one-hour interval. As an example, suppose that a profile configuration for a task specifies gender, age, and country entropies of value one, in which case a prediction model (e.g., neural network) would have been trained so that its output states include gender, age, and country entropies. In this example, if the prediction model (e.g., neural network) predicts that certain hours are more likely to be associated with high gender, age, and country entropies, then those hours might be identified as desirable hours in which to commence or continue recruiting. FIG. 10 is a diagram illustrating an example of a prediction model's (e.g., neural network's) predictions. FIG. 10 follows the above example in which a profile configuration for a task specifies gender, age, and country entropies of value one. Grid 1002 in FIG. 10 represents historical data (organized by feature (e.g., gender, age, and country entropies) and time interval (e.g., hours)) used to train a prediction model (e.g., a neural network) to make predictions. In various embodiments, each box in grid 1002 represents historical data (corresponding to a feature and a time interval) collected over a significant period of time. For example, a box in grid 1002 could represent gender entropies (of available contributor groups) during a specified hour (e.g., noon, according to a specified time zone, such as Pacific Standard Time) over the past three months (e.g., one gender entropy every day for three months). In various embodiments, each row of historical data in grid 1002 is used as training data for prediction model (e.g., a neural network) to generate a predicted time course (e.g., one of the various predicted time courses 1004). As shown in the example illustrated in FIG. 10, the gender entropy row in grid 1002 can be used by a prediction model (e.g., a neural network) to predict gender entropy over a future time period (e.g., the next 24 hours). Similarly, the age entropy row in grid 1002 can be used to generate an age entropy predicted time course, and the country entropy row in grid 1002 can be used to generate a country entropy predicted time course.

The problem to solve (in the example illustrated in FIG. 10) then becomes selecting one or more states (in this example, hours during a 24-hour day) that correspond to meeting the gender, age, and country entropy objectives specified in the profile configuration. For example, one method is to select the hour(s) having the highest unweighted sum of entropies (e.g., maximize gender entropy+age entropy+country entropy). In some embodiments, PyGMO methods that deal with pareto-optimization are used to make this selection. In various embodiments, a subset of intervals (i.e., one or more intervals) that meets the set of one or more objectives better than the other subsets is determined. For the example described above, if a single hour for commencing recruitment is desired, a single hour that meets gender, age, and country entropy objectives better than other hours is determined. Alternatively, if two hours are desired, a subset comprising two one-hour periods is determined. The two one-hour periods need not be consecutive.

At 908, recruiting occurs during the one or more determined intervals of time. In some embodiments, recruiting is configured to occur during specific intervals of time. For example, recruiting may be configured to commence during one determined interval of time, paused, and continued during another determined interval of time. In some embodiments, after recruiting is commenced, recruiting continues periodically until the task for which recruiting was commenced is completed. For example, recruiting may be configured to occur every 20 minutes (i.e., a subset of available contributors that substantially meets a set of one or more objectives is determined every 20 minutes) after recruiting is commenced until a task is completed. In some embodiments, the periodicity with which recruiting occurs after it is commenced is such that recruiting occurs in real time or almost in real time (e.g., if recruiting occurs every minute, recruiting may be considered to occur in real time). A benefit of recruiting during the determined intervals of time is faster recruiting (and thus faster completion of tasks) due to recruiting during intervals of time when desired contributor compositions are more likely to exist. During intervals of time when desired contributor compositions exist, it is likely that more contributors can be recruited than during other intervals of time.

FIG. 10 is a diagram illustrating an example of a prediction model's predictions. See above for a description of how, in some embodiments, these predictions are used to determine when to commence or continue recruiting of contributors.

A framework for recruiting contributors for crowdsourcing tasks has been disclosed. This framework has several benefits. This framework allows for the ability to control compositions of groups of contributors working on various crowdsourcing tasks. Examples of the measurable gains from controlling compositions of groups of contributors include reducing bias in contributions made by contributors, increasing accuracy of contributions made by contributors, and faster recruiting. Furthermore, the framework promotes fair wages and worker satisfaction for contributors, thereby promoting the ethical collection of data.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a profile configuration, the profile configuration comprising a plurality of desired group-level characteristics for a group of contributors to recruit for a task on an electronic crowdsourcing platform, wherein:
the electronic crowdsourcing platform is configured to electronically connect to and communicate with a plurality of contributors via a computer network; and
a contributor of the plurality of contributors is a user that electronically logs into the electronic crowdsourcing platform via the computer network to receive and perform crowdsourcing tasks;
performing a multi-objective optimization to automatically identify, among available ones of the plurality of contributors, a selected set of contributors that substantially meets a set of contributor group-level objectives associated with the task, wherein:
the set of contributor group-level objectives is formulated as an objective function, wherein:
the objective function includes at least two weighted or unweighted variables associated with the plurality of desired group-level characteristics in the profile configuration;
an output value of the objective function is determined using the at least two weighted or unweighted variables; and
the output value of the objective function is used to evaluate the set of contributor group-level objectives for the group of contributors to selectively recruit the selected set of contributors; and
performing the multi-objective optimization includes:
minimizing or maximizing, at least to a substantial degree, the objective function by calculating the objective function for different subset groups of multiple available contributors;
comparing output values of the objective function for at least two subset groups of multiple available contributors; and
identifying the selected set of contributors based at least in part on a corresponding output value of the objective function; and
recruiting the selected set of contributors to perform the task.

2. The method of claim 1, wherein the profile configuration is presented in a visual or graphical format.

3. The method of claim 1, wherein the profile configuration has been created by a requestor of the task.

4. The method of claim 1, wherein the profile configuration has been automatically created, based at least in part on comparing differences in responses from contributors with different traits.

5. The method of claim 1, wherein the plurality of desired group-level characteristics of the profile configuration include desired distributions for contributors according to specified traits of contributors.

6. The method of claim 1, wherein the profile configuration includes a desired gender distribution for contributors.

7. The method of claim 1, wherein the profile configuration includes desired group-level characteristics for software contributors.

8. The method of claim 1, wherein performing the multi-objective optimization to automatically identify the selected set of contributors includes:
determining a first set of contributors that have worked on the task;
determining a second set of contributors that are available to recruit for the task;
determining a first subset of the second set of contributors; and
determining whether a set that is a union of the first set of contributors and the first subset is associated with an output value of the objective function that is closer to a minimum or maximum goal of the objective function than the first set of contributors.

9. The method of claim 8, further comprising:
determining a second subset of the second set of contributors; and
determining whether a set that is a union of the first set of contributors and the second subset is associated with an output value of the objective function that is closer to a minimum or maximum goal of the objective function than the set that is the union of the first set of contributors and the first subset.

10. The method of claim 1, wherein performing the multi-objective optimization to automatically identify the selected set of contributors includes comparing at least two sets of one or more contributors.

11. The method of claim 10, wherein comparing the sets of the one or more contributors includes measuring a distance between two points in a space associated with the objective function.

12. The method of claim 1, wherein performing the multi-objective optimization to automatically identify the selected set of contributors includes:
determining a first subset of contributors of a specified group size to potentially recruit;
determining a second subset of contributors of a different group size to potentially recruit; and
determining whether recruiting the first subset is associated with an output value of the objective function that is closer to a minimum or maximum goal of the objective function than recruiting the second subset.

13. The method of claim 1, further comprising:
identifying one or more intervals of time for commencing or continuing recruiting of contributors.

14. The method of claim 13, wherein the identification of the one or more intervals of time is based at least in part on comparing the profile configuration with features of available contributors during specified intervals of time.

15. The method of claim 13, wherein the identification of the one or more intervals of time is performed by a prediction model.

16. The method of claim 15, wherein the prediction model is trained with historical data that includes features of available contributors during specified intervals of time.

17. The method of claim 1, wherein the recruiting of the selected set of contributors is configurable to be paused and continued.

18. The method of claim 1, wherein the recruiting of the selected set of contributors includes recruiting contributors through the computer network.

19. A system, comprising:
a processor; and
a memory coupled with the processor, wherein the memory is configured to provide the processor with instructions which when executed cause the processor to:
receive a profile configuration, the profile configuration comprising a plurality of desired group-level characteristics for a group of contributors to recruit for a task on an electronic crowdsourcing platform, wherein:
the electronic crowdsourcing platform is configured to electronically connect to and communicate with a plurality of contributors via a computer network; and
a contributor of the plurality of contributors is a user that electronically logs into the electronic crowdsourcing platform via the computer network to receive and perform crowdsourcing tasks;
perform a multi-objective optimization to automatically identify, among available ones of the plurality of contributors, a selected set of contributors that substantially meets a set of contributor group-level objectives associated with the task, wherein:
the set of contributor group-level objectives is formulated as an objective function, wherein:
the objective function includes at least two weighted or unweighted variables associated with the plurality of desired group-level characteristics in the profile configuration;
an output value of the objective function is determined using the at least two weighted or unweighted variables; and
the output value of the objective function is used to evaluate the set of contributor group-level objectives for the group of contributors to selectively recruit the selected set of contributors; and
performing the multi-objective optimization includes:
minimizing or maximizing, at least to a substantial degree, the objective function by calculating the objective function for different subset groups of multiple available contributors;
comparing output values of the objective function for at least two subset groups of multiple available contributors; and
identifying the selected set of contributors based at least in part on a corresponding output value of the objective function; and
recruit the selected set of contributors to perform the task.

20. A computer program product, the computer program product being embodied in a non-transitory computer readable storage medium and comprising computer instructions for:
receiving a profile configuration, the profile configuration comprising a plurality of desired group-level characteristics for a group of contributors to recruit for a task on an electronic crowdsourcing platform, wherein:
the electronic crowdsourcing platform is configured to electronically connect to and communicate with a plurality of contributors via a computer network; and
a contributor of the plurality of contributors is a user that electronically logs into the electronic crowdsourcing platform via the computer network to receive and perform crowdsourcing tasks;
performing a multi-objective optimization to automatically identify, among available ones of the plurality of contributors, a selected set of contributors that substantially meets a set of contributor group-level objectives associated with the task, wherein:
the set of contributor group-level objectives is formulated as an objective function, wherein:
the objective function includes at least two weighted or unweighted variables associated with the plurality of desired group-level characteristics in the profile configuration;
an output value of the objective function is determined using the at least two weighted or unweighted variables; and
the output value of the objective function is used to evaluate the set of contributor group-level objectives for the group of contributors to selectively recruit the selected set of contributors; and
performing the multi-objective optimization includes:
minimizing or maximizing, at least to a substantial degree, the objective function by calculating the objective function for different subset groups of multiple available contributors;
comparing output values of the objective function for at least two subset groups of multiple available contributors; and
identifying the selected set of contributors based at least in part on a corresponding output value of the objective function; and
recruiting the selected set of contributors to perform the task.

21. The method of claim 1, wherein the electronic crowdsourcing platform is configured to monitor work statuses of the plurality of available contributors.

22. The method of claim 1, wherein the electronic crowdsourcing platform is configured to store task performance statistics associated with the plurality of available contributors.

23. The method of claim 1, wherein the profile configuration includes at least two of the following: a desired gender distribution for contributors, a desired age distribution for contributors, a desired language distribution for contributors, and a desired country distribution for contributors.
